(19) United States
(12) Patent Application Publication
(10) Pub. No.: US 2013/0034356 A1
(43) Pub. Date: Feb. 7, 2013

(54) Rogue Optical Network Unit Mitigation in Multiple-Wavelength Passive Optical Networks

(71) Applicants: Yuanqiu Luo, Cranbury, NJ (US); Meng Sui, Shenzhen (CN); Frank Effenberger, Bridgewater, NJ (US)

(72) Inventors: Yuanqiu Luo, Cranbury, NJ (US); Meng Sui, Shenzhen (CN); Frank Effenberger, Bridgewater, NJ (US)

(73) Assignee: FUTUREWEI TECHNOLOGIES, INC., Plano, TX (US)

(21) Appl. No.: 13/566,007

(22) Filed: Aug. 3, 2012

Related U.S. Application Data
(60) Provisional application No. 61/514,762, filed on Aug. 3, 2011.

(51) Int. Cl. H04J 14/02

(52) U.S. Cl. 398/72

(57) ABSTRACT

A method implemented in an optical line terminal (OLT) for reducing adverse effects from a rogue optical network unit (ONU) in a passive optical network (PON), comprising determining with a processor that the rogue ONU is transmitting in violation of pre-specified parameters, and sending at least one message to a plurality of ONUs to change a transmitting wavelength from a first wavelength to a second wavelength.

### CROSS-REFERENCE TO RELATED APPLICATIONS

The present application claims the benefit of U.S. Provisional Patent Application No. 61/514,762 filed Aug. 3, 2011 by Yuanqiu Luo, et al. and entitled “Rogue Optical Network Unit Mitigation in Multiple-Wavelength Passive Optical Networks,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A passive optical network (PON) is a point-to-multipoint, fiber to the premises network architecture in which unpowered optical splitters are used to enable a single optical fiber to serve multiple premises. A PON may consist of an optical line terminal (OLT) at the service provider's central office and a number of optical network units (ONUs) near end users. A PON reduces the amount of fiber and central office equipment required compared with point-to-point architectures. However, because a number of ONUs may share the same wavelength over the optical fiber, problems in one ONU may cause issues for the remainder of the PON.

### SUMMARY

In one embodiment, the disclosure includes a method implemented in an OLT for reducing adverse effects from a rogue ONU in a PON, comprising determining with a processor that the rogue ONU is transmitting in violation of pre-specified parameters, and sending at least one message to a plurality of ONUs to change a transmitting wavelength from a first wavelength to a second wavelength.

In another embodiment, the disclosure includes a network unit, comprising a multiple wavelength transceiver configured to transmit signals at a plurality of wavelengths to a plurality of ONUs and to receive signals from the ONUs, and a logic unit coupled to the multiple wavelength transceiver, wherein the logic unit is configured to send a wavelength change command to the ONUs via the multiple wavelength transceiver when the logic unit determines that one of the ONUs is transmitting outside of predefined parameters.

In another embodiment, the disclosure includes a system for mitigating the impact of a rogue ONU on the performance of a PON, comprising an OLT, and a plurality of ONUs sharing a transmission wavelength, wherein the OLT is configured to send a change wavelength notification to the ONUs when operation outside of pre-specified parameters by one of the ONUs is detected.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a PON according to an embodiment of the disclosure.

FIG. 2 is a schematic diagram of a multiple-wavelength PON system for rogue ONU mitigation in accordance with one embodiment of the disclosure.

FIG. 3 is a protocol diagram illustrating a method for rogue ONU mitigation according to an embodiment of the disclosure.

FIG. 4 is a schematic diagram illustrating an embodiment of a network unit, which may be any device that transports and processes data through the network.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are systems, methods, and apparatuses to mitigate rogue ONU impairment in a multiple-wavelength PON system. A rogue ONU may be an ONU that does not transmit data in a manner compliant with the normal parameters of the PON system. Because a PON has a shared medium in the upstream direction, a rogue ONU can threaten some or all upstream transmissions on the PON. This may generate interference to disrupt communications of some or all of the other ONUs on the PON. Mastered by the PON OLT, ONUs with transmitter wavelength tunability can shift upstream communications on the PON into a different wavelength to avoid the interference from the rogue ONU.

In an embodiment, the PON downstream channel is utilized to instruct well-behaved (i.e., non-rogue) ONUs to change the upstream communications wavelength on which they transmit. This isolates the rogue ONU and minimizes or reduces the rogue ONU' s impairment to the PON as a system since the rogue ONU may continue to transmit on the old wavelength while the other ONUs transmit on the new wavelength. The disclosed methods, systems, and apparatuses may also apply to any PON equipped with ONUs with a tunable wavelength transmitter.

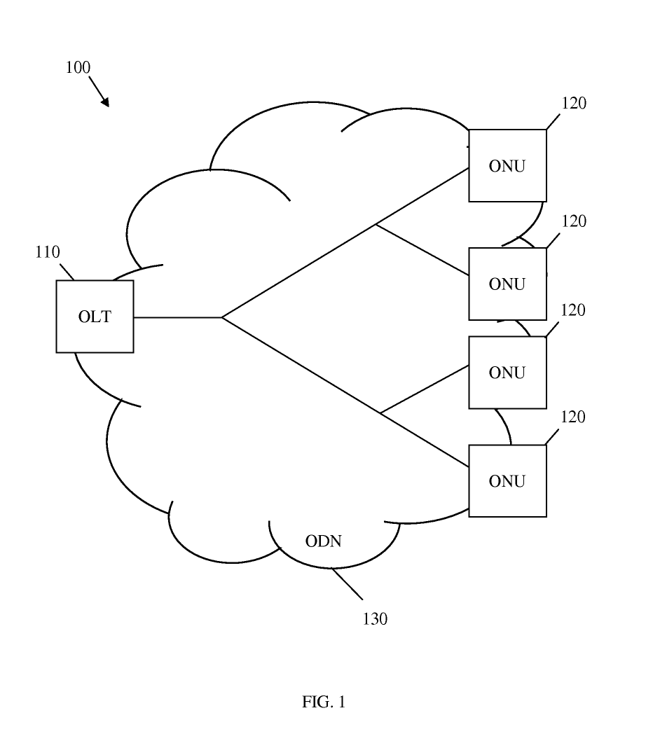

FIG. 1 illustrates one embodiment of a PON 100 according to an embodiment of the disclosure. The PON 100 may comprise an OLT 110, a plurality of ONUs 120, and an optical distribution network (ODN) 130. The PON 100 is a communications network that does not require any active components to distribute data between the OLT 110 and the ONUs 120. Instead, the PON 100 uses the passive optical components in the ODN 130 to distribute data between the OLT 110 and the ONUs 120. Examples of suitable PONs 100 include the asynchronous transfer mode PON (APON) and the broadband PON (BPON) defined by the International Telecommunication Union Telecommunication Standardization Sector (ITU-T) G.983 standard, the Gigabit PON (GPON) defined by the ITU-T G.984 standard, the Ethernet PON (EPON) defined by the Institute of Electrical and Electronics Engineers (IEEE) 802.3ah standard, and the wavelength division multiplexing (WDM) PON (WDM-PON), all of which are incorporated by reference as if reproduced in their entirety.

The OLT 110 may be any device that is configured to communicate with the ONUs 120 and another network (not shown). Specifically, the OLT 110 may act as an intermediary between the other network and the ONUs 120. For instance, the OLT 110 may forward data received from the network to the ONUs 120, and forward data received from the ONUs 120 onto the other network. Although the specific configuration of the OLT 110 may vary depending on the type of PON 100, in an embodiment the OLT 110 may comprise a transmitter and a receiver. When the other network is using a protocol, such as Ethernet or Synchronous Optical Networking/Synchronous Digital Hierarchy (SONET/SDH), that is different from the communications protocol used in the PON 100, the OLT 110 may comprise a converter that converts the other network's data into the PON' s protocol. The converter may also convert the PON's data into the other network's protocol. The OLT 110 described herein is typically located at a central location, such as a central office, but may be located at other locations as well.

The ONUs 120 may be any device that is configured to communicate with the OLT 110 and a customer or user (not shown). Specifically, the ONUs 120 may act as an intermediary between the OLT 110 and the customer. For instance, the ONUs 120 may forward data received from the OLT 110 to the customer, and forward data received from the customer onto the OLT 110. Although the specific configuration of the ONUs 120 may vary depending on the type of PON 100, in an embodiment the ONUs 120 may comprise an optical transmitter configured to send optical signals to the OLT 110. Additionally, the ONUs 120 may comprise an optical receiver configured to receive optical signals from the OLT 110 and a converter that converts the optical signal into electrical signals for the customer, such as signals in the asynchronous transfer mode (ATM) or Ethernet protocol. The ONUs 120 may also comprise a second transmitter and/or receiver that may send and/or receive the electrical signals to a customer device. In some embodiments, ONUs 120 and optical network terminals (ONTs) are similar, and thus the terms are used interchangeably herein. The ONUs 120 are typically located at distributed locations, such as the customer premises, but may be located at other locations as well.

The ODN 130 is a data distribution system that may comprise optical fiber cables, couplers, splitters, distributors, and/or other equipment. In an embodiment, the optical fiber cables, couplers, splitters, distributors, and/or other equipment are passive optical components. Specifically, the optical fiber cables, couplers, splitters, distributors, and/or other equipment may be components that do not require any power to distribute data signals between the OLT 110 and the ONUs 120. It should be noted that the optical fiber cables may be replaced by any optical transmission media in some embodiments. In some embodiments, the ODN 130 may comprise one or more optical amplifiers. The ODN 130 typically extends from the OLT 110 to the ONUs 120 in a branching configuration as shown in FIG. 1, but may be alternatively configured as determined by a person of ordinary skill in the art.

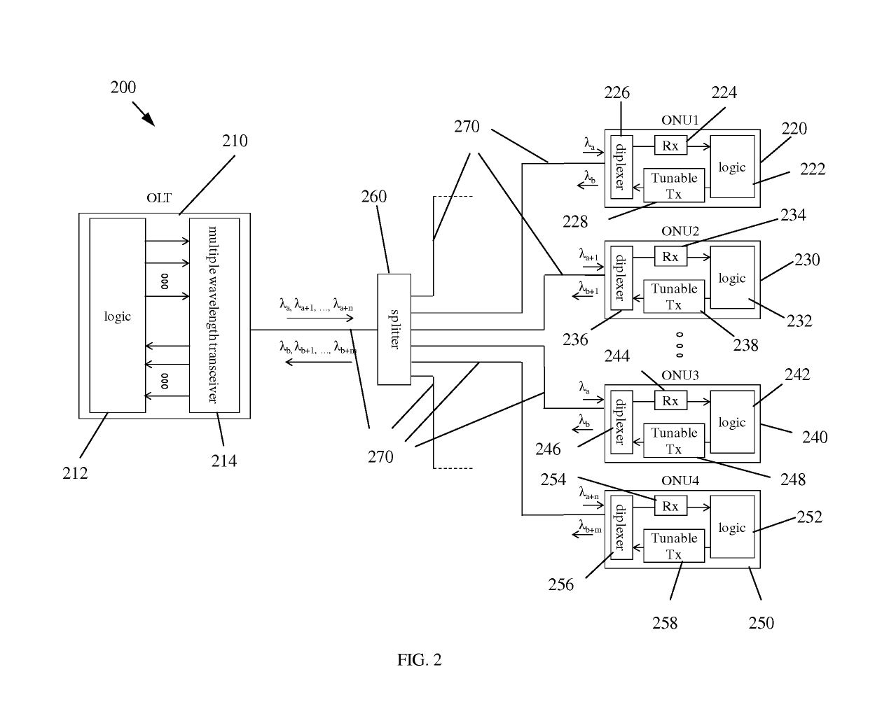

FIG. 2 is a schematic diagram of a multiple-wavelength PON system 200 for rogue ONU mitigation in accordance with one embodiment of the disclosure. PON 200 may comprise an OLT 210, a splitter 260, and a plurality of ONUs 220, 230, 240, 250. The OLT 210, splitter 260, and ONUs 220, 230, 240, 250 may be connected and arranged as shown in FIG. 2. The OLT 210 may comprise a logic component 212 and a multiple wavelength optical transceiver 214. The OLT 210 may receive and transmit multiple wavelengths in both the downstream and upstream directions. Each ONU 220, 230, 240, 250 may comprise a diplexer 226, 236, 246, 256, a receiver 224, 234, 244, 254, a logic component 222, 232, 242, 252, and a tunable transmitter 228, 238, 248, 258, respectively. The ONU receiver 224, 234, 244, 254 may be tunable or fixed. The ONU diplexers 226, 236, 246, 256 may comprise a single stage of splitters, wavelength division multiplexing (WDM) mutliplexers/demultiplexers, or multiple stages of splitters and/or WDM mutliplexers/demultiplexers.

The logic component 212 may be configured to monitor signals received from the ONUs 220, 230, 240, 250 and determine whether one or more of the ONUs is not performing properly (i.e., is a rogue ONU). If the logic component 212 determines that an ONU is not functioning properly and is interfering with the signals transmitted by the other ONUs sharing the same wavelength channel, the logic component 212 may send a notice to all ONUs sharing the wavelength channel with the rogue ONU to change their transmission wavelength to a different wavelength. It is not necessary to determine which of the ONUs 220, 230, 240, 250 that share the same wavelength is rogue. Rather, it is sufficient to detect degraded performance on the channel of the shared wavelength. Typically, the rogue ONU will not respond to commands from the OLT and will not change its upstream transmitting wavelength (if it does so, the rogue ONU can be assigned to its own wavelength channel or turned off). By doing so, the ONUs that were sharing the same wavelength with the rogue ONU may be on a different wavelength from the rogue ONU after the change. Therefore, the rogue ONUs transmissions may not interfere with the transmissions of the other ONUs after the transmission wavelength change. Methods of determining whether one or more ONUs sharing the same wavelength is rogue are well known in the art, but may include determining that the received signal is degraded below what is expected or determining that no upstream signal can be detected.

The multiple wavelength optical transceiver 214 may comprise an optical transmitter and an optical receiver. The optical transmitter may be any device configured to emit an optical signal across a range of optical wavelengths. In an embodiment, the tunable optical transmitter may be a tunable wavelength laser, such as a semiconductor laser or gas laser. For example, the optical transmitter may be a laser diode, a heterostructure laser, a quantum well laser, a quantum cascade laser, a distributed feedback (DFB) laser, or combinations thereof. The optical channels may be Dense WDM (DWDM) channels, as described in the International Telecommunication Union Telecommunication Standardization Sector (ITU-T) G.694.1, coarse WDM (CWDM) channels, as described in the ITU-T G.694.2, or any other optical channels. In embodiments, the wavelength of the optical signal may be varied in the near infrared range (e.g. from about 0.7 micrometers (μm) to about one μm) and/or in the short-wave infrared range (e.g. greater than or equal to about one μm). For example, when the optical signal carried in one of the fibers 270 has a wavelength equal to about 1,625 nanometers (nm), the wavelength of the signal from the optical transmitter 210 may be varied from about 1,618 nm (or about 195,300 Gigahertz (GHz)) to about 1,632 nm (or about 183,700 GHz). The signals from the optical transmitter may be coherent signals that each have a substantially constant phase over sufficiently long time durations, e.g., with limited or substantially no interruptions in transmissions. In some embodiments, a single laser that emits a plurality of signals at a plurality of wavelength channels may be used in the multiple wavelength optical transceiver 214. In an alternative embodiment, an array of single wavelength lasers may be used instead of a tunable wavelength laser to transmit the signals at a plurality of different wavelengths.

The splitter 260 may be any device that separates an optical signal into a plurality of substantially identical optical signals. For example, the splitter 260 may be a 1:n optical coupler (e.g., a 1:2 or 1:3 optical coupler). In an embodiment, the splitter 260 may direct the transmitted signal from the OLT 210 to the ONUs 220, 230, 240, 250. Splitter 260 may also combine signals received from the ONUs 220, 230, 240, 250 onto a single optical transmission media to send to the OLT 210. Splitter 260 may comprise a single splitter or multiple splitters distributed through the ODN. The ODN (not shown) may consist of one splitter stage 260 or wavelength division multiplexing (WDM) mutliplexers/demultiplexers, or multiple stages of splitters and/or WDM mutliplexers/demultiplexers.

The ONU diplexer 226, 236, 246, 256 may provide for receiving and transmitting signals over the same port. Depending on the implementation, the ONU receiver 224, 234, 244, 254 may be tunable or fixed. The ONU transmitter 228, 238, 248, 258 is configured to be able to tune the wavelength to any one of multiple wavelengths. The ONU transmitters 228, 238, 248, 258 may be similar to the multiple wavelength transceiver 214 optical transmitter described above.

When a rogue ONU 220, 230, 240, 250 transmits optical power up the PON 200 in violation of the normal parameters or in another ONU' s 220, 230, 240, 250 transmission timeslots, the upstream channel in the same wavelength may experience deteriorated performance. In the worst case, the OLT 110 cannot detect any expected upstream signals from the wavelength, and the upstream transmission in this wavelength is jammed. For example, in FIG. 2, both ONU1 220 and ONU3 240 employ wavelength λ_{b} in the upstream transmission. If ONU3 240 keeps sending signals to the OLT 210 outside the timeslots allocated to ONU3 240, the OLT 210 cannot receive the transmission from ONU1 220. Transmission from any other ONUs in wavelength λ_{b} would also be impaired.

As discussed above, most rogue ONUs interfere or jam the upstream communication by continually sending uncontrolled signals from the rogue ONUs' transmitters. In a system shown in FIG. 2, ONU transmitter wavelength tunability can be employed to mitigate rogue ONU impairment. Changing the upstream communication channel may eventually shift the upstream transmission into a different wavelength(s), and signal interference of the rogue ONU may be mitigated.

Once the OLT 210 detects rogue behavior, the following steps may be conducted to reduce or mitigate the problem. The OLT 210 may send a notice or message to the impacted ONUs 220, 230, 240, 250 via the downstream channel notifying the impacted ONUs 220, 230, 240, 250 to change their upstream wavelength into a different one (or multiple different wavelengths). The message may comprise a broadcast message to some or all the ONUs 220, 230, 240, 250 or may comprise a plurality of unicast messages with each ONU 220, 230, 240, 250 receiving its own unicast message. The impacted ONUs 220, 230, 240, 250 may tune their transmitter wavelengths by following the OLT 210 instruction. In some embodiments, wavelength change responses may be sent from the ONUs 220, 230, 240, 250 to the OLT 210. After a reasonable settling time or after receiving wavelength change responses, the OLT 210 may master transmission of the impacted ONUs 220, 230, 240, 250 in the new upstream wavelength(s) as in regular operation.

In order to make the upstream wavelength change decision, the OLT 210 may be knowledgeable of upstream wavelength availability and ONU wavelength tunability. If all of the impacted ONUs 220, 230, 240, 250 use the same downstream wavelength, one downstream broadcast message could be enough to carry the upstream wavelength change command. In the case that the impacted ONUs 220, 230, 240, 250 are in multiple downstream wavelength channels, each downstream wavelength channel may require a broadcast message for the notification purpose.

Wavelength change responses from ONUs 220, 230, 240, 250 are optional. When an impacted ONU 220, 230, 240, 250 supports partial wavelength tunablity, the response from the ONU 220, 230, 240, 250 notifies the OLT 210 of the actual wavelength the ONU 220, 230, 240, 250 that could be reached. The actual wavelength is the best effort made by the ONU 220, 230, 240, 250 with the ONU' s 220, 230, 240, 250 limited wavelength tunability.

The OLT 210 may start regular operation once the upstream wavelength change is finished. Note that the ONU 220, 230, 240, 250 ranging times may change because of the upstream wavelength change. In most cases, the threshold of drift of window (DOWi) is able to handle this matter. When the ranging time change is above the threshold, re-ranging may be required to update the ONU 220, 230, 240, 250 equalization delay. After re-ranging, the impacted ONUs 220, 230, 240, 250 may be able to communicate with the OLT 210 via the new wavelength(s).

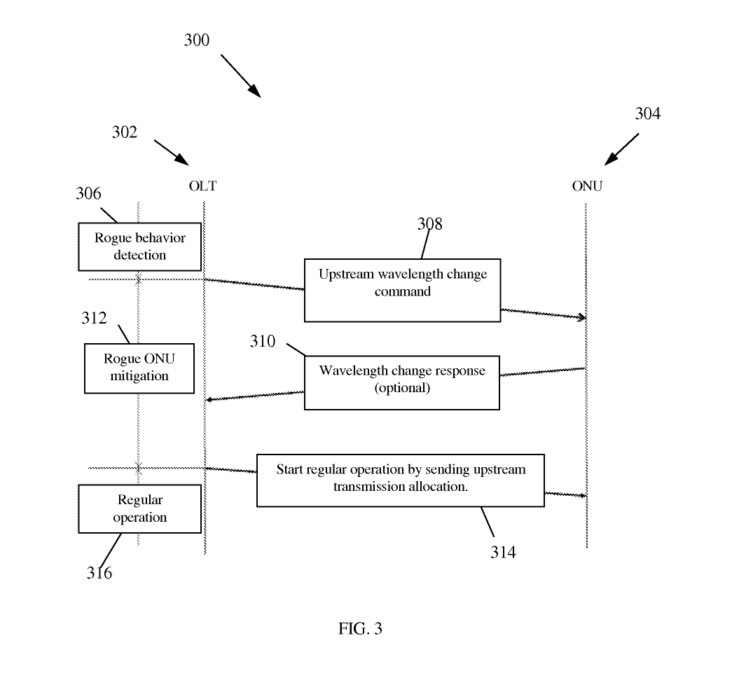

FIG. 3 is a protocol diagram illustrating a method 300 for rogue ONU mitigation according to an embodiment of the disclosure. At step 306, the OLT 302 may detect rogue ONU behavior. At step 308, the OLT 302 may transmit an upstream wavelength change command to each ONU 304 sharing the same wavelength on which the rogue ONU behavior was detected. The ONUs 304 that are not acting in a rogue manner will change their upstream transmitting wavelength to the new wavelength assigned by the OLT 302. At step 310, the ONUs 304 may optionally transmit a wavelength change response to the OLT 302. The OLT 302 may wait for a rogue ONU mitigation time duration 312 before proceeding with regular operation 316. The rogue ONU mitigation time duration 312 may be a specified time period or may be the time at which the wavelength change response message is received from the ONUs 304. At step 314, the OLT resumes regular operation by sending upstream transmission allocation to the ONUs 304. After a reasonable settling time or after receiving the wavelength change response message(s) from the ONUs 304, the OLT 302 may send an upstream bandwidth allocation message in a downstream channel to the impacted ONUs for operation in the new upstream wavelength(s) as in regular operation.

There are three main methods to send the upstream wavelength change command and wavelength change response shown in FIG. 3. The first method is the embedded channel of in-band frame fields and embedded structures. Examples are the embedded Operations, Administration, and Maintenance (OAM) in Giga-PON (G-PON) and Ten G-PON (XG-PON), and the Logical Link Identifier (LLID) in Ethernet PON (EPON) and Ten Giga EPON (10GEPON). The second method is the control message channel. Examples are the physical layer OAM (PLOAM) messages in G-PON and XG-PON1, and the multi-point control protocol (MPCP) messages in EPON and lOGEPON. Table 1 gives an example of a PLOAM message of upstream wavelength change. Table 2 shows a wavelength change response physical layer operations and maintenance (PLOAM) message.

TABLE 1
Upstream wavelength change PLOAM message.

| Octet | Content |
|---|---|
| 1-2 | Broadcast |
| 3 | Message type ID |
| 4 | Sequence number |
| 5~a | ONU Tx wavelength |
| (a + 1)~b | ONU Tx new wavelength |
| (b + 1)~40 | Reserved or padding |
| 41-48 | Message integrity check |

TABLE 2
Wavelength change response PLOAM message.

| Octet | Content |
|---|---|
| 1-2 | Assigned ONU-ID |
| 3 | Message type ID |
| 4 | Sequence number |
| 5~a | Instructed ONU Tx wavelength |
| (a + 1)~b | Actual ONU Tx wavelength |
| (b + 1)~40 | Reserved or padding |
| 41-48 | Message integrity check |

The third method is the data channel. In G-PON and XG-PON1, special GPON Encapsulation Method (GEM) or XGPON Encapsulation Method (XGEM) ports can be configured by ONU management and control interface (OMCI) for this purpose. In EPON and lOGEPON, LLIDs can be designed for this purpose.

Additional details concerning methods to send the upstream wavelength change command and wavelength change response may be found in U.S. Patent Application No. 61/473,439 entitled “Wavelength Indication in Multiple-Wavelength Passive Optical Networks” by Luo, et al. filed Apr. 8, 2011, which is incorporated herein by reference as if reproduced in its entirety. Additional details may also be found in ITU-T Recommendations G.984.3 and G.987.3 and in IEEE Standards 802.3ah and 802.3av, all of which are incorporated herein by reference as if reproduced in their entirety.

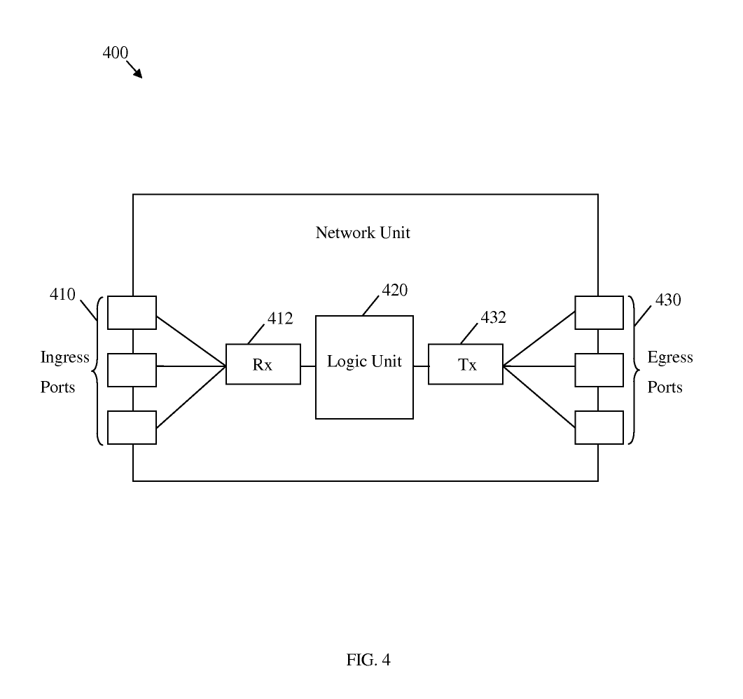

FIG. 4 illustrates an embodiment of a network unit 400, which may be any device that transports and processes data through the network. For instance, the network unit 400 may correspond to or may be located at an OLT or an ONU, such as OLT 210 or ONUs 220, 230, 240, 250 described above. The network unit 400 may comprise one or more ingress ports or units 410 coupled to a receiver (Rx) 412 for receiving signals and frames/data from other network components. The network unit 400 may comprise a logic unit 420 to determine which network components to send data to. The logic unit 420 may be implemented using hardware, software, or both. The network unit 400 may also comprise one or more egress ports or units 430 coupled to a transmitter (Tx) 432 for transmitting signals and frames/data to the other network components. The receiver 412, logic unit 420, and transmitter 432 may also implement or support the rogue ONU mitigation method 300 described above. The components of the network unit 400 may be arranged as shown in FIG. 4.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. The use of the term about means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method implemented in an optical line terminal (OLT) for reducing adverse effects from a rogue optical network unit (ONU) in a passive optical network (PON), comprising:
determining with a processor that the rogue ONU is transmitting in violation of pre-specified parameters; and
sending at least one message to a plurality of ONUs to change a transmitting wavelength from a first wavelength to a second wavelength.

2. The method of claim 1, wherein determining with the processor that the rogue ONU is transmitting in violation of pre-specified parameters comprises determining that the rogue ONU is transmitting in other ONUs' transmission time slots.

3. The method of claim 1, wherein determining with the processor that the rogue ONU is transmitting outside of assigned time slots comprises determining that an upstream channel is experiencing deteriorated performance.

4. The method of claim 1, wherein determining with the processor that the rogue ONU is transmitting in violation of pre-specified parameters comprises determining that the rogue ONU is transmitting outside of transmitting timeslots assigned to the rogue ONU.

5. The method of claim 1, wherein determining with the processor that the rogue ONU is transmitting in violation of pre-specified parameters comprises determining that the OLT cannot detect an expected upstream signal.

6. The method of claim 1, further comprising sending an upstream wavelength allocation message to at least some of the plurality of ONUs.

7. The method of claim 6, wherein the upstream wavelength allocation message is sent after expiration of a settling time.

8. The method of claim 6, wherein the upstream wavelength allocation message is sent after receiving a plurality of wavelength change responses from the ONUs.

9. The method of claim 1, further comprising sending an upstream transmission allocation on the second wavelength.

10. The method of claim 1, wherein the at least one message comprises a single broadcast message.

11. The method of claim 1, wherein the at least one message comprises a plurality of unicast messages.

12. An optical line terminal (OLT), comprising:
a multiple wavelength transceiver configured to transmit signals at a plurality of wavelengths to a plurality of optical network units (ONUs) and to receive signals from the ONUs; and
a logic unit coupled to the multiple wavelength transceiver, wherein the logic unit is configured to send a wavelength change command to the ONUs via the multiple wavelength transceiver when the logic unit determines that one of the ONUs is transmitting outside of predefined parameters.

13. The OLT of claim 12, wherein the logic unit is configured to determine that one of the ONUs is transmitting outside of predefined parameters when the one ONU is transmitting in another ONU' s transmission time slot.

14. The OLT of claim 12, wherein the logic unit is configured to determine that one of the ONUs is transmitting outside of predefined parameters when an upstream channel is experiencing deteriorated performance.

15. The OLT of claim 12, wherein the logic unit is configured to determine that one of the ONUs is transmitting outside of predefined parameters when the OLT cannot detect an expected upstream signal.

16. The OLT of claim 12, wherein the logic unit is further configured to instruct the transmitter to send an upstream wavelength allocation message to at least some of the plurality of ONUs.

17. The OLT of claim 16, wherein the logic unit is further configured to instruct the transmitter to send the upstream wavelength allocation message after expiration of a settling time.

18. The OLT of claim 16, wherein the logic unit is further configured to instruct the transmitter to send the upstream wavelength allocation message after the transmitter receives a wavelength change response from the ONUs.

19. The OLT of claim 12, wherein the logic unit is further configured to instruct the transmitter to send an upstream transmission allocation.

20. A system for mitigating the impact of a rogue optical network unit (ONU) on the performance of a passive optical network (PON), comprising:
an optical line terminal (OLT); and
a plurality of ONUs sharing an upstream transmission wavelength,
wherein the OLT is configured to send a change upstream wavelength notification to the ONUs when operation outside of pre-specified parameters by one of the ONUs is detected.

21. The system of claim 20, wherein the OLT is configured to determine that one of the ONUs is operating outside of pre-specified parameters when the one ONU is transmitting in another ONU's transmission time slot.

22. The system of claim 20, wherein the OLT is configured to determine that one of the ONUs is operating outside of pre-specified parameters when an upstream channel is experiencing deteriorated performance.

23. The system of claim 20, wherein the OLT is configured to determine that one of the ONUs is operating outside of pre-specified parameters when the one ONU is transmitting outside of transmitting timeslots assigned to the one ONU.

24. The system of claim 20, wherein the OLT is configured to determine that one of the ONUs is operating outside of pre-specified parameters when the OLT cannot detect an expected upstream signal.
